(19) United States
(12) Patent Application Publication
(10) Pub. No.: US 2017/0298168 A1
(43) Pub. Date: Oct. 19, 2017

(54) GLUCOSE-BASED BLOCK COPOLYMERS

(71) Applicant: Regents of the University of Minnesota, Minneapolis, MN (US)

(72) Inventors: Theresa Reineke, Vadnais Heights, MN (US); Mohammadreza Nasiri, Minneapolis, MN (US)

(21) Appl. No.: 15/490,379

(22) Filed: Apr. 18, 2017

Related U.S. Application Data
(60) Provisional application No. 62/323,997, filed on Apr. 18, 2016.

(51) Int. Cl. C08F 293/00; C09J 153/00

(52) U.S. Cl. CPC C08F 293/005; C09J 153/00; C08F 2438/03; C09J 2453/00; C09J 2205/114

(57) ABSTRACT

An example block copolymer may include at least one poly(glucose-6-acrylate) (G6A) block. An example technique may include treating glucose-6-acrylate-1,2,3,4-tetraacetate (GATA) monomer and n-butyl acrylate (nBA) monomer with a free radical initiator in the presence of a chain transfer agent (CTA).

This application claims the benefit of U.S. Provisional Application No. 62/323,997 filed Apr. 18, 2016, which is incorporated herein by reference in its entirety.

### GOVERNMENT RIGHTS

This invention was made with government support under CHE-1413862 and DMR-1420013 awarded by the National Science Foundation, and under DE-AC02-06CH11357 awarded by the Department of Energy. The government has certain rights in the invention.

### TECHNICAL FIELD

This disclosure relates to glucose-based block copolymers.

### BACKGROUND

Thermoplastic elastomers (TPEs) may include ABA triblock copolymers, for example, styrene-based copolymers such as poly(styrene)-b-poly(butadiene)-b-poly(styrene) (SBS) and poly(styrene)-b-poly(isoprene)-b-poly(styrene) (SIS). However, styrene-based materials may be derived from nonrenewable feedstocks, such as petroleum. The manufacturing and disposal of petroleum-based materials such as styrene may have a negative environmental impact.

While TPEs have been developed from sustainable and plant-based feedstock sources, they typically include lactide and lactone derivatives. For example, poly(lactide) (PLA) may be used as the glassy component in tri- and multiblock copolymers with rubbery poly(ethylene glycol) blocks, to create thermoplastic elastomers. Alternative TPEs may include rubbery blocks from sustainable feedstocks, for example, ABA triblock copolymers of menthide and lactide monomers, or soybean oil derived monomers in triblock copolymers.

A need continues for sustainable source-based elastomeric materials that exhibit properties comparable to those of petroleum-derived elastomeric materials while having a reasonable cost.

### SUMMARY

In some examples, the disclosure describes an example composition comprising a block copolymer. The block copolymer includes at least one poly(glucose-6-acrylate) (G6A) block.

In some examples, the disclosure describes an example composition comprising a block copolymer. The block copolymer may include at least one glassy block comprising repeating units of poly(glucose-6-acrylate-1,2,3,4-tetraacetate). The block copolymer may include at least one other block comprising repeating units of one or more monomers chosen from:

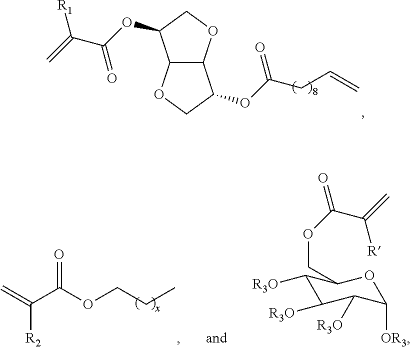

wherein R₁═CH₃ or H, R₂═CH₃ or H, X=2-10, R=Me or H, and wherein R₃═H, Ac, Me, or Et.

In some examples, the disclosure describes an example technique for preparing a glucose-based copolymer. The example technique includes treating glucose-6-acrylate-1,2,3,4-tetraacetate) (GATA) monomer and n-butyl acrylate (nBA) monomer with a free radical initiator in the presence of a chain transfer agent (CTA) to form a block copolymer. The block copolymer may include at least one poly(GATA) block and at least one poly(nBA) block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating a reaction mechanism for producing GATA from glucose.

FIG. 2 is a conceptual diagram illustrating a reaction mechanism for producing a poly(GATA)-b-poly(nBA) copolymer from GATA monomer and nBA monomer using a chain transfer agent.

FIG. 3 is a conceptual diagram illustrating a reaction mechanism for producing a poly(GATA)-b-poly(nBA)-b-poly(GATA) copolymer from GATA monomer and nBA monomer through an intermediate poly(GATA) polymer using a chain transfer agent.

FIG. 4 is a conceptual diagram illustrating a reaction mechanism for producing a poly(GATA)-b-poly(nBA)-b-poly(GATA) copolymer from GATA monomer and nBA monomer through an intermediate poly(nBA) polymer using a chain transfer agent.

FIG. 5A is a chart presenting an nmr spectrum for GATA monomer. FIG. 5B is a chart presenting an nmr spectrum for a poly(GATA) polymer chain. FIG. 5C is a chart presenting an nmr spectrum for a poly(GATA)-b-poly(nBA) copolymer chain.

FIGS. 6A-6D are charts presenting differential refractive index as a function of elution time obtained by gel permeation chromatography on sample polymers.

FIGS. 7A-7C are charts presenting 1-dimensional synchrotron small-angle X-ray scattering (SAXS) analysis of sample polymers.

FIG. 8 is a chart presenting stress-strain curves for sample polymers.

FIG. 9 is a chart presenting stress-strain curves for sample polymers.

### DETAILED DESCRIPTION

The disclosure describes glucose-based block copolymers and techniques for preparing glucose-based copolymers. In examples according to the disclosure, free radical polymerization may be used to prepare a block copolymer of a glucose-based monomer, for example, glucose-6-acrylate-1,2,3,4-tetraacetate (GATA) and another monomer, for example, n-butyl acrylate (nBA). As discussed in examples below, reversible addition-fragmentation chain Transfer (RAFT) polymerization may be used to prepare the copolymer, for example, by treating GATA and nBA in the presence of a suitable chain transfer agent (CTA). The example polymers may include different terminal end groups and junction blocks depending, for example, on the chain transfer agent (CTA) used, the free radical initiators used, and the reaction conditions. In some examples, example block copolymers according to the disclosure may include a thermoplastic elastomer.

In some examples, an example composition may include at least one poly(glucose-6-acrylate) (G6A) block. The poly(G6A) block may be substituted at one more sites. For example, the poly(G6A) block may include at least one block including repeating units of one or more monomers having a formula:

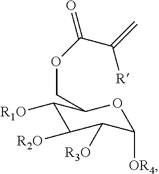

where R′=Me or H, and wherein one or more of R₁, R₂, R₃, or R₄ are same or different, and wherein R₁, R₂, R₃, or R₄═H, Ac, Me, or Et. In some examples, the poly (G6A) block may include at least one poly(GATA) block. In some examples, the example composition including at least one poly(G6A) block may further include at least one poly(nBA) block.

In some examples, an example composition may include an example block copolymer that includes at least one poly(GATA) (or PGATA) block and at least one poly(nBA) (or PnBA) block. For example, an example block copolymer may include poly(GATA)-b-poly(nBA), or poly(GATA)-b-poly(nBA)-b-poly(GATA), or any other block copolymer including at least one poly(GATA) and at least one poly(nBA) block. In some examples, an example block copolymer may include a junction block. For example, the junction block may link two side chains including one or more blocks across a junction. In some examples, the junction block may include at least one of a trithiocarbonate junction or a 3,5-Bis(loxopropoxy)benzoic acid junction.

In some examples, an example block copolymer may include a polymer having a formula chosen from:

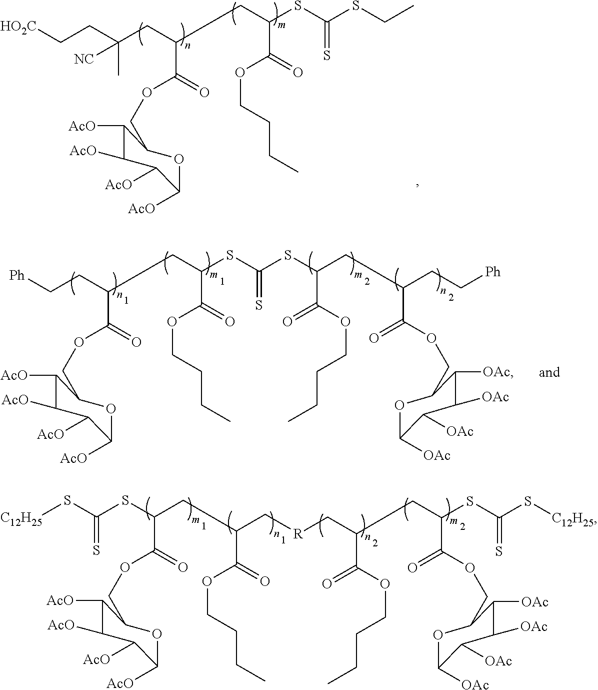

wherein

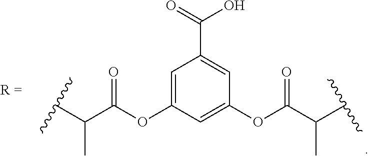 [SMILES: *C(C)C(=O)Oc1cc(OC(=O)C(*)C)cc(C(=O)O)c1]

In some examples, n, n₁, n₂, m, m₁, m₂ may be integers. For example, one or more of n, n₁, n₂, m, m₁, and m₂ may be integers within the range of from about 1 to about 10, from about 1 to about 100, from about 1 to about 1000, from about 1 to about 10,000, from about 10 to about 100, from about 10 to about 1000, from about 100 to about 10,000, or any other target range. In some examples, n₁ and n₂ may be substantially equal. For example, n₁ and n₂ may differ by less than 100, by less than 10, by less than 5, or may be exactly the same. In some examples, m₁ and m₂ may be substantially equal. For example, m₁ and m₂ may differ by less than 100, by less than 10, by less than 5, or may be exactly the same.

In some examples, the example block copolymer may include a junction block. The junction block may include at least one of a trithiocarbonate junction or a 3,5-Bis(loxopropoxy)benzoic acid junction. In some examples, example compositions according to the disclosure may include example block copolymers that have a substantially symmetric structure about the junction block. For example, each side chain linked to the junction block may have substantially the same chain length or molecular weight.

In some examples, an example composition may include an example block copolymer that may include at least one glassy block and at least one other block. For example, the at least one glassy block may include repeating units of poly(GATA), and the at least one other block may include repeating units of one or more monomers chosen from:

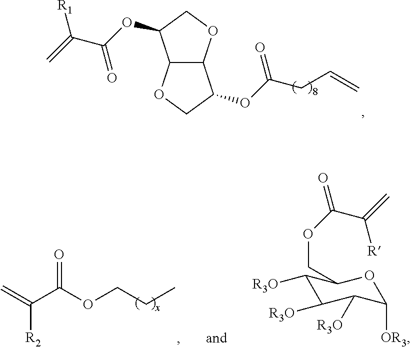

wherein R₁═CH₃ or H, R₂═CH₃ or H, X=2-10, R=Me or H, and wherein R₃═H, Ac, Me, or Et. In some examples, the at least one other block may include a hard block, for example, when the block includes glucose-based monomer units. In some examples, the at least one other block may include a soft block, for example, when the block includes monomers corresponding to the first two members of the group listed above.

In some examples, example block copolymers may have a weight-averaged molecular weight within a range of from about 500 to about 500,000 g/mol, from about 750 to about 500,000 g/mol, from about 1,000 to about 500,000, from about 10,000 to about 500,000, from about 15,000 to about 500,000, from about 20,000 to about 500,000, from about 500 to about 200,000 g/mol, from about 1,000 to about 200,000, from about 10,000 to about 200,000, from about 15,000 to about 200,000, from about 20,000 to about 200,000, from about 500 to about 100,000 g/mol, from about 1,000 to about 100,000, from about 10,000 to about 100,000, from about 15,000 to about 100,000, from about 20,000 to about 100,000, from about 1,000 to about 50,000, from about 10,000 to about 50,000, from about 15,000 to about 50,000, from about 20,000 to about 50,000, from about 10,000 to about 40,000, from about 15,000 to about 40,000, from about 20,000 to about 40,000, less than about 500,000, less than about 250,000, less than about 100,000, less than about 75,000, less than about 70,000, less than about 60,000, less than about 50,000, less than about 40,000, or less than about 30,000 g/mol. In some examples, example block copolymers according to the disclosure may have a molecular weight from about 10,000 to about 50,000 g/mol. In some examples, the example block copolymers according to the disclosure may have a molecular weight of about 20,000 to about 40,000 g/mol.

In some examples, an example composition may include a pressure sensitive adhesive, and the pressure sensitive adhesive may include one or more example block copolymers according to the disclosure. In some examples, example compositions according to the disclosure may have a peel adhesion value of greater than or equal to about 0.1 N/cm, greater than or equal to about 1 N/cm, greater than or equal to about 2 N/cm, or greater than or equal to about 5 N/cm. In some examples, example compositions according to the disclosure may have a peel adhesion value of less than or equal to about 10 N/cm, less than or equal to about 5 N/cm, less than or equal to about 2 N/cm, or less than or equal to about 1 N/cm. In some examples, example compositions according to the disclosure may have a peel adhesion value of 0.1 N/cm to 1 N/cm, or 0.1 N/cm to 5 N/cm, or 0.1 N/cm to 10 N/cm, or 1 N/cm to 2 N/cm, or 1 N/cm to 5 N/cm, or 1N/cm to 10 N/cm, or 5 N/cm to 10 N/cm.

In some examples, example compositions may include a tackifier. For example, the tackifier may include aromatic or aliphatic hydrocarbon resins, hydrogenated resins, rosin esters, polyisobutylene, phenolics, polyterpenes, and mixed olefins.

In some examples, example block copolymers according to the disclosure may have a thermal decomposition temperature of greater than or equal to about 200° C., greater than or equal to about 225° C., greater than or equal to about 250° C., greater than or equal to about 275° C., or greater than or equal to about 300° C. The thermal decomposition temperature may be associated with a weight loss of less than or equal to about 10%, less than or equal to about 5%. less than or equal to about 2.5%, or less than equal to about 1%. In some examples, example block copolymers according to the disclosure may have a thermal decomposition temperature of greater than or about 275° C. at a weight loss of about 5%.

Without being bound by theory, longer block lengths may increase the adhesive and peel performance of polymers. For example, an ABA-type triblock copolymer with a relatively longer midblock (‘B’) compared to the end blocks (‘A’) may exhibit a higher degree of entanglements within the resulting polymer network, which may lead to improvement in properties. The relative length of the midblock (‘B’) compared to that of the endblocks (‘A’) may be tuned based on a predetermined target property of the copolymer. A triblock copolymer with longer block lengths may also lead to a stronger phase segregation upon self-assembly, which may result in higher shear strength in the material. The shear strength has a direct relationship with polymers performance, and may be affect the properties and the stability of the polymer, for example, under high temperature conditions.

Example mechanisms and techniques according to the disclosure may be used to prepare example compositions including block copolymers. The block copolymers may include one or more of a poly(G6A) block, a poly(GATA) block, or a poly(nBA) block. In some examples, the poly(GATA) block may be considered to be a type of a poly(G6A) block. In other examples, an example block copolymer may include at least a first poly(G6A) block and at least a second poly(GATA) block where the poly(GATA) block may be different from the poly(G6A) block. The block copolymers may also include a junction block.

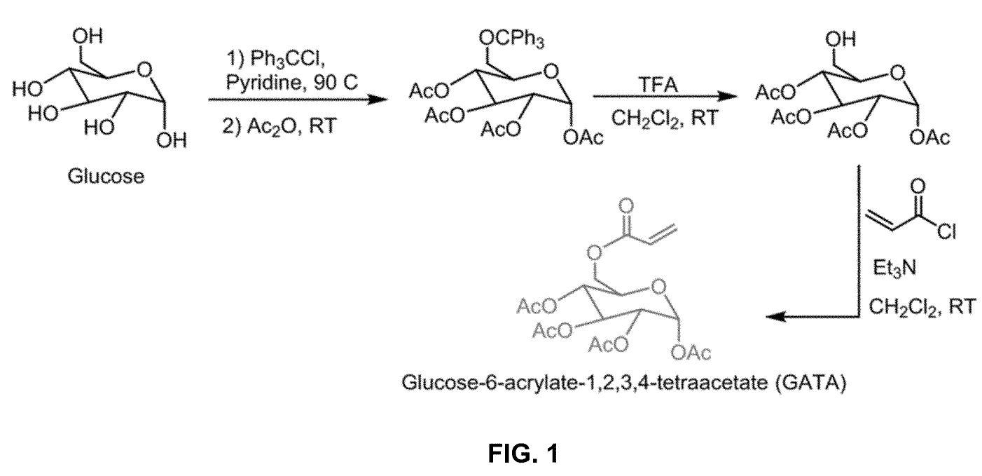

FIG. 1 is a conceptual diagram illustrating an example reaction mechanism for producing GATA from glucose. In some examples, in an initial reaction step, the primary hydroxyl group on glucose may be protected with a trityl group, for example, —CPh₃, by treating glucose with trityl chloride in the presence of pyridine, followed by full acetylation of the remaining hydroxyl groups by treating the trityl-protected glucose with acetic anhydride. Thus, the initial reaction step may result in the production of 6-trityl-d-glucose-1,2,3,4-tetraacetate (TGTA). In a subsequent reaction step, the trityl protecting group may be selectively removed from the acetylated trityl protected glucose (TGTA) by treating TGTA with trifluoroacetic acid (TFA) in the presence of dichloromethane, to produce D-glucose-1,2,3,4-tetraacetate (GTA), in which the primary hydroxyl group is unprotected and available for functionalization. In a final reaction step, an acrylate functional group may be provided on the re-exposed primary hydroxyl group in the detritylated acetylated glucose (GTA) by esterifying GTA with acryloyl chloride, to prepare GATA. While GATA monomer prepared from glucose by the example reaction mechanism of FIG. 1 may be used to prepare example block copolymers, in some examples, GATA prepared by any other suitable reaction mechanism may be used.

While example compositions may include polymeric blocks including repeating GATA monomer units, for example, poly(GATA) blocks, in some examples, example compositions may include polymeric blocks including repeating (glucose-6-acrylate) (G6A) monomer units, for example, poly(G6A) blocks. In some examples, the G6A units may be mono- or poly-substituted or functionalized. For example, an example composition may include at least one poly(glucose-6-acrylate) (G6A) block. The poly(G6A) block may be substituted at one more sites. The poly(G6A) block may include at least one block including repeating units of one or more monomers having a formula:

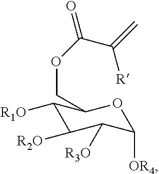

where R′=Me or H, and wherein one or more of R₁, R₂, R₃, or R₄ are same or different, and wherein R₁, R₂, R₃, or R₄═H, Ac, Me, or Et. In some examples, the poly (G6A) block may include at least one poly(GATA) block. Example block copolymers prepared using one or both of GATA monomer or G6A monomer are described below.

In some examples, an example technique may include 14 treating GATA monomer and nBA monomer with a free radical initiator in the presence of a chain transfer agent (CTA) to form a block copolymer. For example, RAFT polymerization may be used to copolymerize GATA and nBA to form a block copolymer. The block copolymer may include at least one poly(GATA) block and at least one poly(nBA) block.

In some examples, the free radical initiator may include any suitable species capable of initiating free radical reactions. For example, the free radical initiator may include one or more of azo compounds, halogens, and organic peroxides. In some examples, azo compounds used as free radical initiators may include 1,1′-azobis(cyclohexanecarbonitrile) (ABCN), 4,4′-azobis(4-cyanopentanoic acid), and azobisisobutyronitrile (AIBN). In some examples, the free radical initiator may consist of AIBN.

In some examples, the CTA may include a thiocarbonylthio group. The CTA may be selected based on their compatibility with the selected monomers, the target polymerization reaction kinetics and the target copolymer structure. For example, the CTA may be chosen from 4-cyano-4-[(ethylsulfanylthiocarbonyl)sulfanyl] pentanoic acid (CEP), S,S-dibenzyl trithiocarbonate, and 3,5-Bis(2-dodecylthiocarbonothioylthio-loxopropoxy)benzoic acid.

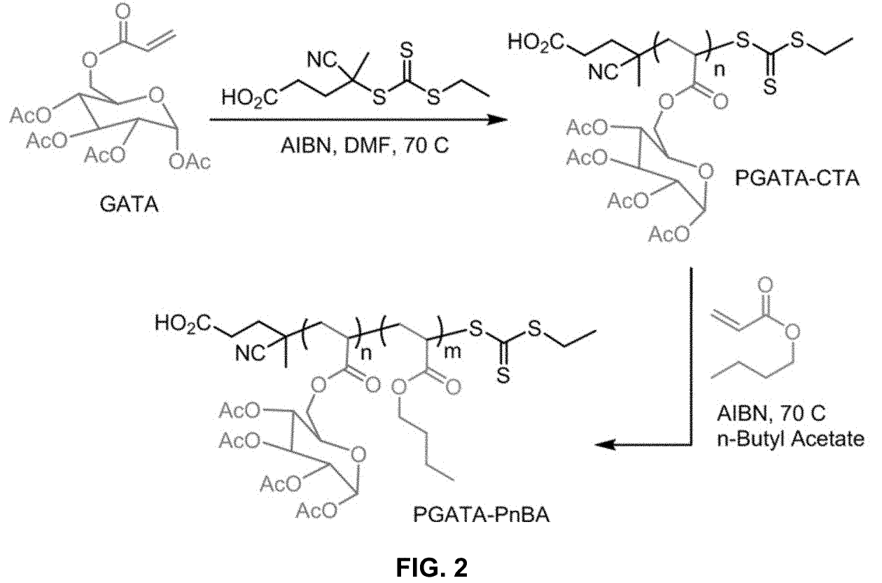

FIG. 2 is a conceptual diagram illustrating an example reaction mechanism for producing a poly(GATA)-b-poly(nBA) copolymer from GATA monomer and nBA monomer using CEP as a CTA. In the example reaction mechanism of FIG. 2, RAFT polymerization of GATA monomer may be employed to synthesize a glassy block, where the glassy block includes repeating units of GATA, or poly(GATA). A solvent that may include one or more of dimethylformamide (DMF) or n-butyl acetate may be used in one or more steps of the reaction. GATA monomer may be treated with CEP as the CTA in the presence a free radical initiator, for example, AIBN, to form a poly(GATA)-CTA intermediate (for example, poly(GATA) macro-CTA). In some examples, any other suitable free radical initiator may be used. The poly(GATA)-CTA intermediate may be treated with nBA in the presence of a free radical initiator, for example, AIBN, or another free radical initiator, in the presence of a suitable solvent such as n-butyl acetate, to yield poly(GATA)-b-poly(nBA) block copolymers (for example, diblock copolymers). In some examples, the poly(nBA) block may be a soft block.

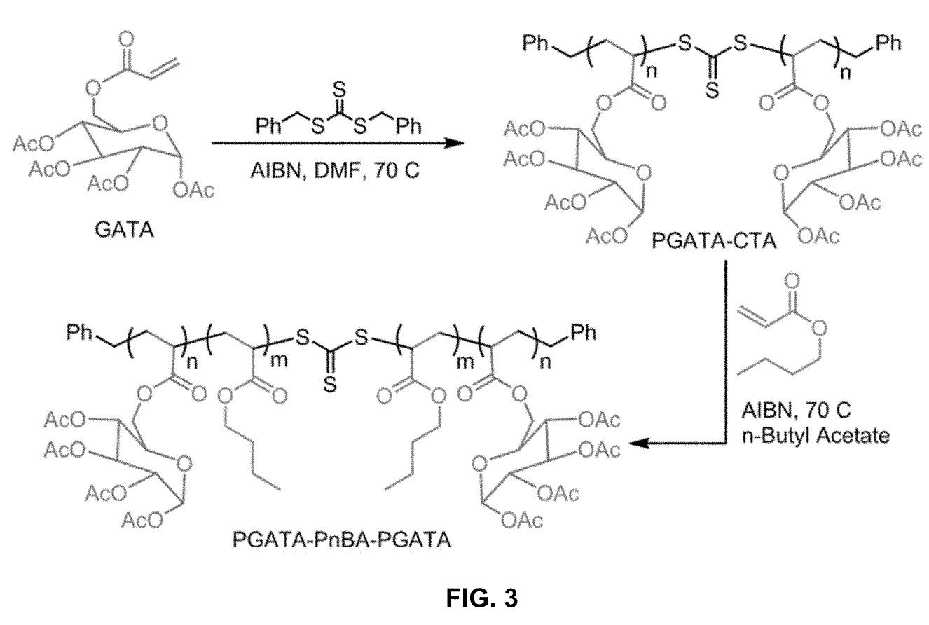

FIG. 3 is a conceptual diagram illustrating an example reaction mechanism for producing a poly(GATA)-b-poly(nBA)-b-poly(GATA) copolymer from GATA monomer and nBA monomer through an intermediate poly(GATA) polymer using a symmetric trithiocarbonate CTA. In the example reaction mechanism of FIG. 3, the CTA may include S,S-dibenzyl trithiocarbonate (DTC) for a two-step synthesis. A solvent that may include one or more of DMF or n-butyl acetate may be used in one or more steps of the reaction. In the first step, GATA may be treated with DTC in the presence of a free radical initiator, for example, AIBN, to form a substantially symmetric poly(GATA)-CTA intermediate that may include a junction block, for example, a trithio junction. In some examples, as shown in FIG. 3, both chains of the poly(GATA) linked to the trithio junction may have exactly the same chain length (n). However, in other examples, the chains may have similar lengths, for example, n₁ and n₂, where n₁ and n₂ may differ by less than about 100, less than about 10, or less than about 5. In the second step, the symmetric poly(GATA)-CTA intermediate may be treated with nBA in the presence of a free radical initiator, for example, AIBN, and optionally in the presence of n-butyl acetate, to form a poly(GATA)-b-poly(nBA)-b-poly(GATA) copolymer. In some examples, as shown in FIG. 3, both chains of the poly(nBA) linked to the trithio junction may have exactly the same chain length (m). However, in other examples, the chains may have similar lengths, for example, m₁ and m₂, where m₁ and m₂ may differ by less than about 100, less than about 10, or less than about 5. In some examples, the resulting copolymer may have at least one poly(GATA) and at least one poly(nBA) block on each side of the junction block. In the example reaction mechanism of FIG. 3, the reaction may proceed by an inner-growing chain transfer. For example, first, poly(GATA) blocks grow linked to the junction block, and then poly(nBA) chains grow inwardly between the junction block and the outer poly(GATA) block. Thus, example techniques for producing block copolymers according to the disclosure may include treating GATA monomer with a CTA to form a poly(GATA)-CTA intermediate and treating the poly(GATA)-CTA intermediate with the nBA monomer.

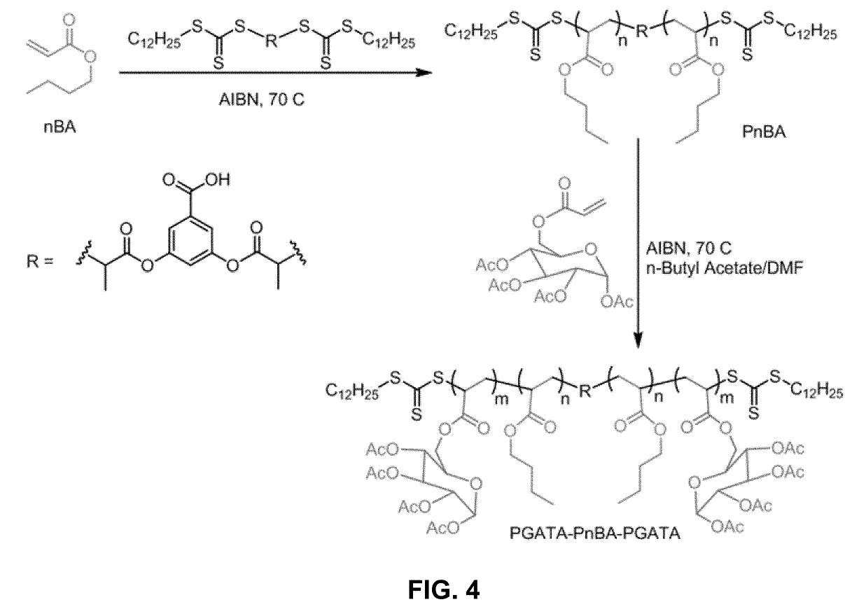

FIG. 4 is a conceptual diagram illustrating an example reaction mechanism for producing a poly(GATA)-b-poly(nBA)-b-poly(GATA) copolymer from GATA monomer and nBA monomer through an intermediate poly(GATA) polymer using a symmetric benzoic acid trithiocarbonate CTA. In the example reaction mechanism of FIG. 4, the CTA may include 3,5-Bis(2-dodecylthiocarbonothioylthio-loxopropoxy)benzoic acid (BTCBA) for a two-step synthesis. A solvent that may include one or more of DMF or n-butyl acetate may be used in one or more steps of the reaction. In the first step, nBA may be treated with BTCBA in the presence of a free radical initiator, for example, AIBN, to form a substantially symmetric poly(nBA)-CTA intermediate that may include a junction block, for example, a benzoic acid junction or a 3,5-Bis(loxopropoxy)benzoic acid junction. In some examples, as shown in FIG. 4, both chains of the poly(nBA) linked to the benzoic acid junction may have exactly the same chain length (n). However, in other examples, the chains may have similar lengths, for example, n₁ and n₂, where n₁ and n₂ may differ by less than about 100, less than about 10, or less than about 5. In the second step, the substantially symmetric poly(nBA)-CTA intermediate may be treated with GATA, in the presence of a free radical initiator, for example, AIBN, and optionally in the presence of n-butyl acetate, to form a poly(GATA)-b-poly(nBA)-b-poly(GATA) copolymer. In some examples, as shown in FIG. 4, both chains of the poly(GATA) linked to the benzoic acid junction through the poly(nBA) blocks may have exactly the same chain length (m). However, in other examples, the chains may have similar lengths, for example, m₁ and m₂, where m₁ and m₂ may differ by less than about 100, less than about 10, or less than about 5. In some examples, the resulting copolymer may have at least one poly(GATA) and at least one poly(nBA) block on each side of the junction block. In the example reaction mechanism of FIG. 4, the reaction may proceed by an outer-growing chain transfer. For example, first, poly(nBA) blocks grow linked to the junction block, and then poly(GATA) chains grow outwardly from the poly(GATA) blocks linked to the inner junction block. Thus, example techniques for producing block copolymers according to the disclosure may include treating nBA monomer with a CTA to form a poly(nBA)-CTA intermediate and treating the poly(nBA)-CTA intermediate with the nBA monomer.

Example block copolymers according to the disclosure may include at least one poly (G6A) block. In some examples, an example block copolymer may include may a poly(GATA) block. In some examples, example block copolymers may include at least one poly(nBA) block, for example, in addition to at least one poly(G6A) block. Example block copolymers according to the disclosure may exhibits suitable peel adhesion strength for use as adhesives, and may exhibit relatively high thermal stability. Thus, examples of block copolymers prepared from sustainable sources that provide properties comparable to those of petroleum-based copolymers have been described.

The present disclosure will be illustrated by the following non-limiting examples.

### Examples

### Example 1—Preparation of GATA from Glucose

GATA monomer was prepared from glucose. To a dried one liter round bottom flask, anhydrous D-(+)-glucose (30.0 g, 167 mmol), trityl chloride (50.0 g, 180 mmol), and anhydrous pyridine (125 ml) were added sequentially. The mixture was placed in a preheated, well-mixed oil bath at 90° C. until everything was fully dissolved. Then, acetic anhydride (90 ml) was added in one portion and allowed to stir at room temperature with the removal of the oil bath for 16 h. Afterward, the solution was slowly poured into a mixture of 4 liters of ice water and 250 ml acetic acid and then vigorously stirred for 4 hours. The resultant white precipitate was filtered and washed with cold water and dried under fume hood overnight. The solid obtained was dispersed in 100 ml ethyl ether and stirred for 10 minutes. The solid obtained was vacuum filtered to afford 6-trityl-d-glucose-1,2,3,4-tetraacetate (TGTA) (49.5 g, 50.2% isolated yield). ¹H NMR (CDCl₃): δ 1.60-2.20 (m, 12H, CH₃—CO); 3.05 (dd, 1H); 3.33 (dd, 1H), 3.63-3.75 (m, 1H); 5.10-5.30 (m, 3H); 5.68-5.78 (m, 1H, O—CH—O—CO—CH₃); 7.15-7.50 (m, 15H) ppm.

Next, TGTA (25.0 g, 42.4 mmol), 2 ml water, and 40 ml dichloromethane were mixed in a 250 ml round bottom flask. 12.5 ml trifluroacetic acid was slowly added and the mixture stirred at room temperature for 10 minutes. The mixture was diluted with 100 ml dichloromethane and 100 ml water and transferred into a separatory funnel. Another wash with dichloromethane was performed with 200 ml dichloromethane. The organic wash solutions were combined and washed with a saturated solution of NaHCO₃ (250 ml) and then water (2×250 ml). The organic layers were then dried over magnesium sulfate and concentrated by rotary evaporation. The resulting viscous solution was dissolved in a minimum amount of anhydrous ether, and agitated with a glass rod to induce recrystallization, which was left in a refrigerator overnight. The resulting white crystals, D-glucose-1,2,3,4-tetraacetate (GTA, 10.8 g, 73.0% isolated yield) were vacuum filtered and dried at ambient conditions. ¹H NMR (CDCl₃): δ 2.00-2.12 (m, 12H, CH₃—CO); 2.21 (dd, 1H, —CH₂—OH); 3.54-3.82 (m, 3H), 5.05-5.15 (m, 2H); 5.31 (t, 1H); 5.72 (d, 1H, O—CH—CH—OH) ppm.

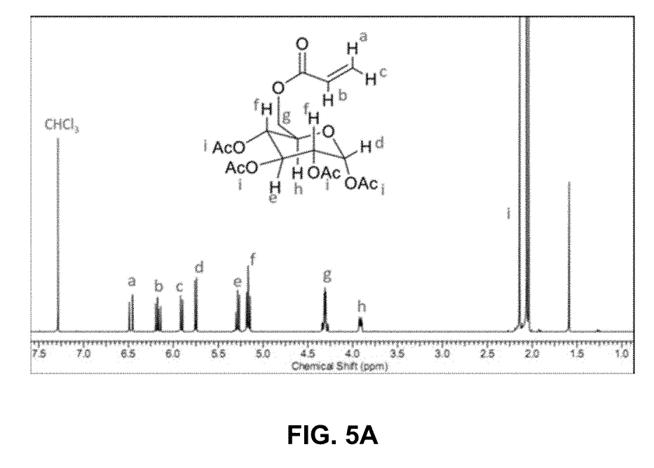

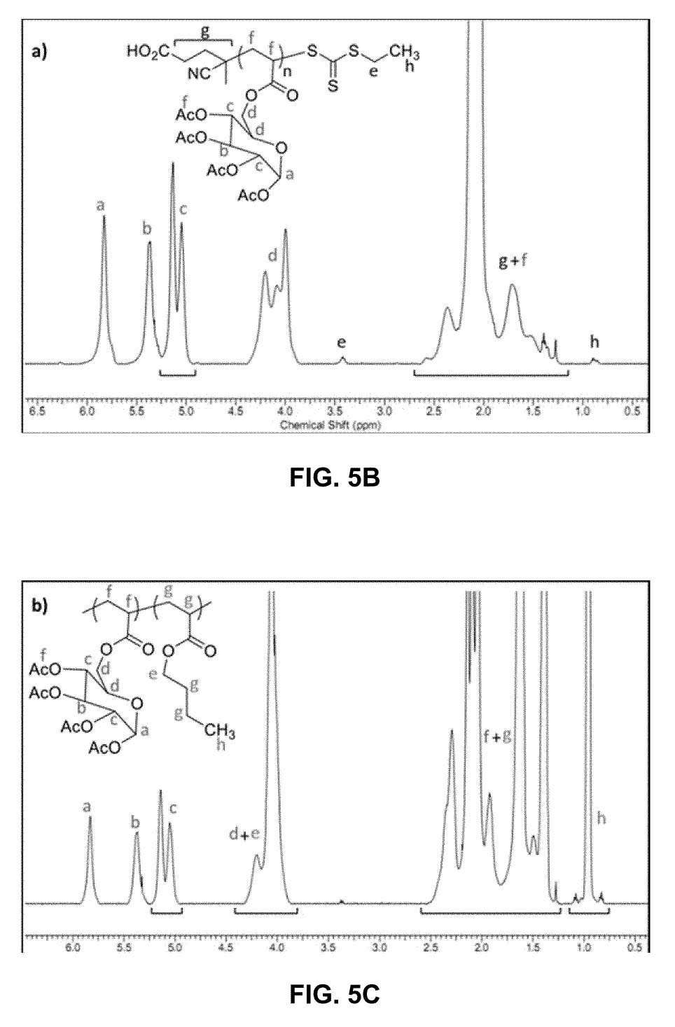

Next, a solution of GTA (5.00 g, 14.4 mmol) and triethylamine (4.35 g, 43.1 mmol) in 20 ml dichloromethane was added dropwise to a stirred 0° C. solution of acryloyl chloride (3.60 g, 39.8 mmol) in 100 ml dichloromethane in a 250 ml round bottom flask. After 2 h, the mixture was allowed to warm to room temperature and was stirred for an additional 14 h. The solvent was then removed by evaporation. The remaining solid was dissolved in 10 ml dichloromethane and passed through a plug of silica gel using 500 ml of an ethyl acetate:hexanes (80:20) mixture. The solvent was removed to afford glucose-6-acrylate-1,2,3,4-tetraacetate (GATA, 5.15 g, 88.9% isolated yield). ¹H NMR (CDCl₃): δ 1.95-2.15 (m, 12H, CH₃—CO); 3.84-3.91 (m, 1H), 4.20-4.30 (m, 2H), 5.08-5.14 (m, 2H), 5.23 (t, 1H), 5.70 (d, 1H, O—CH—CH—OH), 5.86 (d, 1H), 6.12 (dd, 1H), 6.42 (d, 1H) ppm. FIG. 5A is a chart presenting an nmr spectrum for GATA monomer. All ¹H NMR spectra were recorded at room temperature on a Bruker Avance III 500 MHz Spectrometer in CDCl₃ as the solvent. Chemical shifts are reported relative to the Tetramethylsilane (TMS) internal standard peak at 0.00 ppm.

### Example 2—Preparation of Poly(GATA)

Sample P1 was prepared: to a 10 ml round-bottom flask equipped with a teflon stirring bar was added 4-cyano-4-(ethylsulfanylthiocarbonyl) sulfanylpentanoic acid (CEP) (29.0 mg, 0.110 mmol), AIBN (1.80 mg, 0.011 mmol), GATA (2.00 g, 4.98 mmol), and 3 ml of dimethylformamide (DMF). The flask was sealed and the mixture was degassed by purging with nitrogen at room temperature for 30 minutes. Subsequently, the reaction vessel was submerged into a thermostated oil bath at 70° C. for 13 hours. The polymerization was quenched by immediately placing the flask into liquid nitrogen and opening it to air. The reaction mixture was diluted by adding 2 ml of methylene chloride, and subsequently the polymer was precipitated in 100 ml of ice-cold methanol. The yellow solid was isolated via filtration and the resulting poly(GATA)-CTA powder was dried under vacuum at 40° C. (1.70 g, 85.0% isolated yield). Mₙ=21 kg·mol⁻¹ (full conversion), [symbol] =1.17. ¹HNMR (CDCl₃, 500 MHz): δ=1.4-2.5 (br m, CH, CH₂, CH₃), 3.9-4.4 (br m, CH₂ and CH), 5-5.2 (br m, CH and CH), 5.3-5.5 (br m, CH), 5.7-5.9 (br m, CH) ppm. FIG. 5B is a chart presenting an nmr spectrum for poly(GATA)-CTA.

### Example 3—Preparation of Poly(nBA)

The synthesis of poly(nBA) macro-CTA was performed in bulk. AIBN (3.50 mg, 0.021 mmol), 3,5-bis(2-dodecylthiocarbonothioylthio-1-oxopropoxy)benzoic acid (BTCBA) (100 mg, 0.122 mmol), and n-butyl acrylate (9.80 ml, 68.1 mmol) were mixed in a 25 ml round-bottom flask equipped with a teflon stirring bar. The flask was sealed and the mixture was degassed under inert nitrogen at room temperature for 45 minutes. Subsequently, the reaction vessel was submerged into a preheated, stirring oil bath maintained at 70° C. After 1.5 hours, the reaction was quenched by immediately placing the flask into liquid nitrogen and opening it to air. 10 ml of CH₂Cl₂ was added to the mixture, and subsequently the polymer was precipitated in 400 ml of ice-cold methanol and was left in the freezer for two hours. The precipitates were isolated by decanting off the supernatant fluid. The procedure was repeated three times and precipitates were dried under vacuum at 40° C. (4.15 g, 61.2% isolated yield). Mₙ (poly(nBA))=56 kg·mol⁻¹ (78% conversion), [symbol] =1.04. ¹HNMR (CDCl₃, 500 MHz): δ=0.9-1.1 (m, CH₃), 1.2-2 (br m, CH₂, CH₂, CH₂), 2.2-2.4 (br m, CH), 3.9-4.1 (br m, CH₂).

### Example 4—Preparation of Poly(GATA)-b-Poly(nBA)

To examine the ability to target different block lengths with high control, a series of diblocks (poly(GATA)-b-poly(nBA)) with various component ratios were synthesized (P4-P6, Table 1), from P1 as the macro-CTA (FIG. 2). These systems displayed excellent thermal stability (T_{d}≧275° C.). Additionally, in all cases, the diblocks exhibited two well-separated glass transition temperatures (T_{g}), which are near the T_{g} values of the respective homopolymers (104° C. and −50° C. for poly(GATA) and Poly(nBA), respectively), indicating microphase separation between the poly(GATA) and poly(nBA) domains. These results indicated that these segments were promising for further study by synthesizing ABA-type triblock copolymers, which will enable physically cross-linked networks for TPE applications. Thus, we were inspired to proceed with the sequential polymerization to construct poly(GATA)-b-poly(nBA)-b-poly(GATA) triblock copolymers with this same synthetic procedure. However, attempts to sequentially add a third block via RAFT polymerization on the poly(nBA) end of the diblock macro-CTA were unsuccessful.

Sample P5 was prepared: to synthesize the poly(GATA)-poly(nBA) block copolymer, AIBN (0.660 mg, 0.004 mmol), the relevant macro-CTA (i.e. poly(GATA)-CEP) (P1) (300 mg, 0.014 mmol), nBA (1.50 ml, 10.4 mmol) and 5 ml of n-butyl acetate were mixed in a 10 ml round-bottom flask equipped with a teflon stirring bar. The flask was sealed and the mixture was degassed under inert nitrogen at room temperature for 30 minutes. Subsequently, the reaction vessel was submerged into a preheated, stirred oil bath maintained at 70° C. After 14 hours, the reaction was quenched by immediately placing the flask into liquid nitrogen and opening it to air. CH₂Cl₂ (2 ml) was added to the mixture, and subsequently the polymer was precipitated in 150 ml of ice-cold methanol. The precipitates were isolated via gravity filtration and dried under vacuum at 40° C. (1.00 g, 82.8% isolated yield). Mₙ (poly(nBA))=65 kg·mol⁻¹ (68% conversion), [symbol] =1.20. ¹HNMR (CDCl₃, 500 MHz): 6=0.9-1.1 (m, CH₃-poly(nBA)), 1.3-2.4 (br m, CH-poly(GATA) and poly(nBA), CH₂-poly(GATA) and poly(nBA), CH₃-poly(GATA), CH₂-poly(nBA), CH₂-poly(nBA)), 3.9-4.4 (br m, CH₂-poly(GATA) and poly(nBA), CH-poly(GATA)), 5-5.2 (br m, CH-poly(GATA) and CH-poly(GATA)), 5.3-5.5 (br m, CH-poly(GATA)), 5.7-5.9 (br m, CH-poly(GATA)). FIG. 5C is a chart presenting an nmr spectrum for poly(GATA)-b-poly(nBA).

### Example 5—Preparation of Poly(GATA)-b-Poly(nBA)-Trithiocarbonate-Poly(nBA)-b-Poly(GATA)

P2 and P3 poly(GATA) homopolymers with DTC as CTA were subsequently chain extended with n-butyl acrylate to yield the triblock copolymers listed in Table 1 (P7-P9) (FIG. 3). Similar to the diblock analogs, the triblock copolymers showed excellent thermal stability (with decomposition temperatures higher than 279° C.) along with two well-separated T_{g} values (˜−45° C. and ˜105° C. for the poly(nBA) and poly(GATA) domains, respectively). Close inspection of the size exclusion chromatography (SEC) traces shows that there is a lower molar mass shoulder with the triblocks, which can be attributed to the dead chains from the macro-CTA synthesis.

Sample P9 was prepared: to synthesize the triblock copolymers that carry the trithiocarbonate functionality within the midblock, AIBN (0.500 mg, 0.003 mmol), the relevant macro-CTA (i.e. poly(GATA)-DTC macro-CTA) (P3) (150 mg, 0.007 mmol), nBA (1.25 ml, 8.69 mmol) and 6 ml of n-butyl acetate were mixed in a 10 ml round-bottom flask equipped with a teflon stirring bar. The flask was sealed and the mixture was degassed under inert nitrogen at room temperature for 45 minutes. Subsequently, the reaction vessel was submerged into a preheated, stirred oil bath maintained at 80° C. After 52 hours, the reaction was quenched by immediately placing the flask into liquid nitrogen and opening it to air. CH₂Cl₂ (2 ml) was added to the mixture, and subsequently the polymer was precipitated in 200 ml of ice-cold methanol. The precipitates were isolated via gravity filtration and dried under vacuum at 40° C. (750 mg, 73.0% isolated yield). Mₙ (poly(nBA))=126 kg·mol⁻¹ (79% conversion), [symbol] =1.16. ¹HNMR (CDCl₃, 500 MHz): δ=0.9-1.1 (m, CH₃-poly(nBA)), 1.3-2.4 (br m, CH-poly(GATA) and poly(nBA), CH₂-poly(GATA) and poly(nBA), CH₃-poly(GATA), CH₂-poly(nBA), CH₂-poly(nBA)), 3.9-4.4 (br m, CH₂-poly(GATA) and poly(nBA), CH-poly(GATA)), 5-5.2 (br m, CH-poly(GATA) and CH-poly(GATA)), 5.3-5.5 (br m, CH-poly(GATA)), 5.7-5.9 (br m, CH-poly(GATA)).

### Example 6—Preparation of Poly(GATA)-b-Poly(nBA)-Benzoic Acid-Poly(nBA)-b-Poly(GATA)

To improve the potential scalability, stability, and processability of the triblock TPEs, another polymerization pathway was explored that employed 3,5-Bis(2-dodecylthiocarbonothioylthio-loxopropoxy)benzoic acid (BTCBA) as the CTA. This bifunctional CTA leaves the cleavable trithiocarbonate groups on the ends of the polymer chains (FIG. 4), while maintaining a facile two-step synthesis for the desired triblocks. Final triblock copolymer structures were achieved with excellent control as low dispersities ( [symbol] ≦1.08) were achieved. Using BTCBA as the CTA demonstrated that this strategy offers an efficient and effective route for advanced development of these materials. FIG. 3 shows the clear shift to higher molar mass elution times with the increase in the GATA content. A summary of the characteristics for this new family of triblock copolymers is provided in Table 2. Similar to the previous analogous copolymers, excellent thermal stabilities were observed (T_{d}≧264° C.). Triblocks with 12, 19 and 25% of GATA content were prepared in a controlled manner. The glass transition for the soft domains (poly(nBA) block) was evidently observed in differential scanning calorimetry (DSC), however, a clear transition was not observed for the hard domains (GATA blocks). One possible explanation for this lack of clear GATA T_{g} in the DSC could be small heat change during the glass transitions for these polymers, attributed to their short poly(GATA) segments (approximately 4, 6, and 9 kDa endblocks, compared to poly(GATA) segments greater than 11 kDa for the previous di and triblocks). It should be noted that even the glass transitions observed for the previous triblocks, with endblocks ≧11 kDa, was a very small transition.

Sample P12 was prepared: to synthesize triblock copolymers with the bifunctional CTA, AIBN (0.600 mg, 0.004 mmol), the relevant macro-CTA (i.e. poly(nBA)-BTCBA macro-CTA) (1.00 g, 0.018 mmol), GATA (600 mg, 1.49 mmol), 4 ml of n-butyl acetate, and one ml of dimethylformamide were mixed in a 10 ml round-bottom flask equipped with a teflon stirring bar. The flask was sealed and the mixture was degassed under inert nitrogen at room temperature for 45 minutes. Subsequently, the reaction vessel was submerged into a preheated, stirred oil bath maintained at 70° C. After 43 hours, the reaction was quenched by immediately placing the flask into liquid nitrogen and opening it to air. CH₂Cl₂ (2 ml) was added to the mixture, and subsequently the polymer was precipitated in 300 ml of ice-cold methanol. The precipitates were isolated via gravity filtration and dried under vacuum at 40° C. (1.10 g, 89.1% isolated yield). Mₙ (poly(GATA))=13 kg·mol⁻¹ (39% conversion), [symbol] =1.07. ¹H NMR (CDCl₃, 500 MHz): δ=0.9-1.1 (m, CH₃-poly(nBA)), 1.3-2.4 (br m, CH-poly(GATA) and poly(nBA), CH₂-poly(GATA) and poly(nBA), CH₃-poly(GATA), CH₂-poly(nBA), CH₂-poly(nBA)), 3.9-4.4 (br m, CH₂-poly(GATA) and poly(nBA), CH-poly(GATA)), 5-5.2 (br m, CH-poly(GATA) and CH-poly(GATA)), 5.3-5.5 (br m, CH-poly(GATA)), 5.7-5.9 (br m, CH-poly(GATA)).

### Example 7—Size Exclusion Chromatography

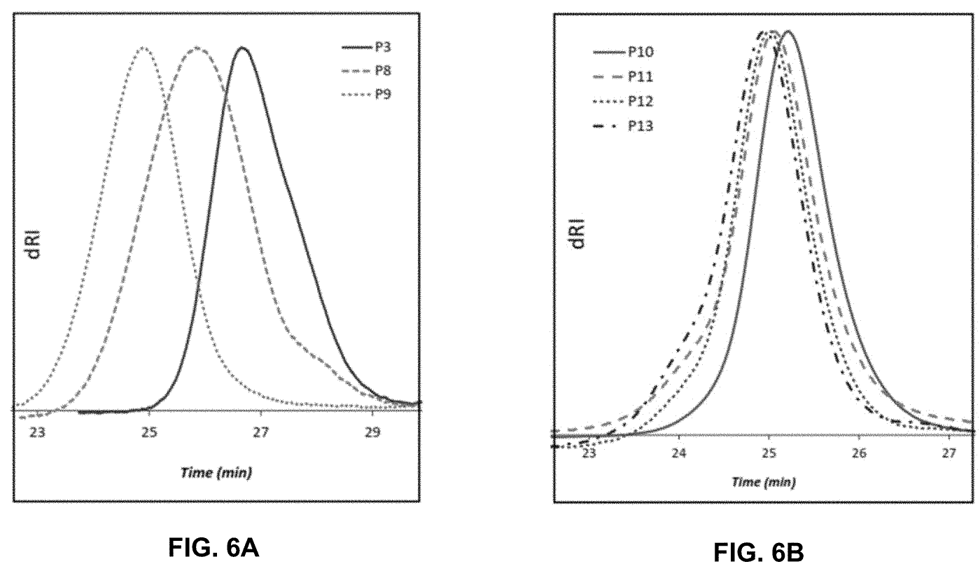

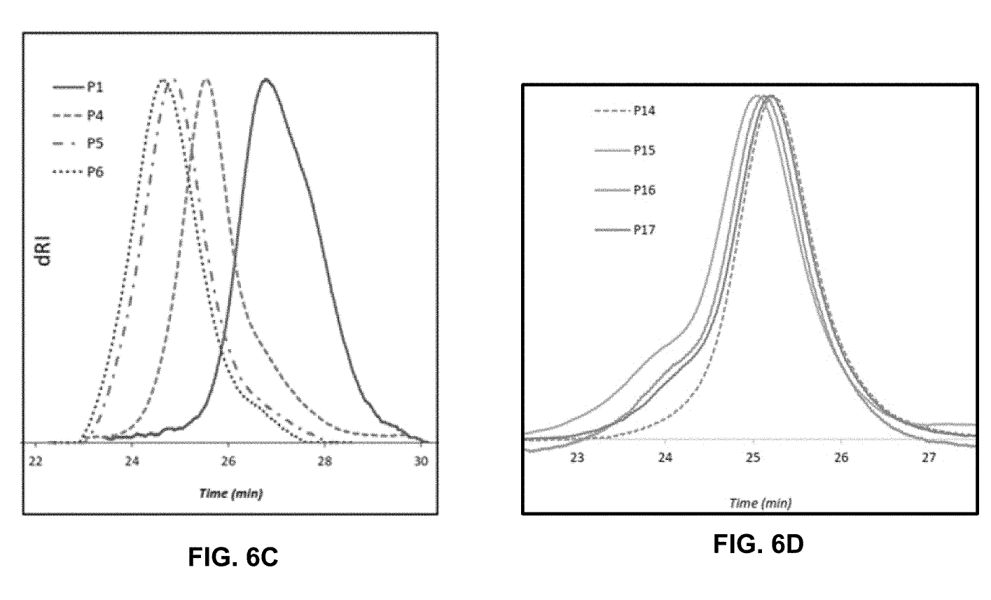

FIGS. 6A-6D are charts presenting differential refractive index as a function of elution time obtained by gel permeation chromatography on sample polymers. Size-exclusion chromatography (SEC) was performed in THF using a Waters Styragel guard column and 3 Waters Styragel columns (HR6, HR4, and HR1) in series with separation ability of 100-10,000,000 g·mol⁻¹. The columns were contained in an Agilent 1260 Infinity liquid chromatograph equipped with a Wyatt Dawn Heleos II multiangle light scattering detector and a Wyatt Optilab T-rEX refractive index detector. The do/dc values were calculated from the refractive index signal using a known sample concentration and assuming 100% mass recovery from the column and were used for molar mass calculations.

The properties of samples P1-P17 are summarized in TABLE 1. Both the diblocks and triblocks presented in TABLE 1 were prepared in various GATA weight percentages and with low dispersities, which supports a successful utilization of the RAFT mechanism for copolymerization of GATA and nBA. Although this approach offers a two-step synthesis for the desired triblocks, some of the resulting copolymers carry a trithiocarbonate functionality within the midblock. This internal trithiocarbonate may impact the processability of the materials at high temperatures as this group may be susceptible to degradation via high temperature or hydrolysis.

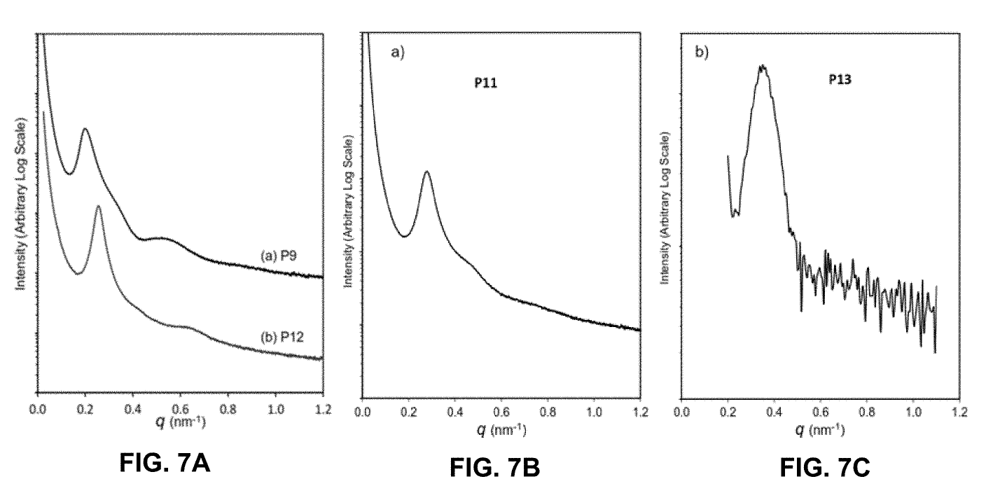

GATA, a glucose-based monomer, was used for the design of sustainable thermoplastic elastomers. The ABA architecture of these triblock copolymers, which are comprised of a rubbery and low T_{g} midblock (poly(nBA)) and two hard and high T_{g} end-segments (poly(GATA)), provides a template that can form a network via physical cross-linking between the two domains when phase-separated at room temperature. ABA-type copolymers are appealing for TPE applications and P9, as an illustrative example, was selected to be examined for its PSA properties. Alternative polymerization pathways were explored and both diblock and triblock polymers with narrow molar mass distributions were synthesized by RAFT polymerization. BTCBA, a bifunctional chain transfer agent, provided a simple and straightforward two-step synthesis for the desired ABA (poly(GATA)-b-poly(nBA)-b-poly(GATA)) triblock copolymers. Phase-separation of the blocks was found by SAXS analysis (FIGS. 7A-7C) and the triblock copolymers demonstrated moderate mechanical properties with excellent thermomechanical and adhesion properties.

TABLE 1

| | | Mₙ^{a} | Mₙ^{b} | | GATA | GATA | | |
|---|---|---|---|---|---|---|---|---|
| | Sample | (kDa, | (kDa, | | wt % | wt % | T_{d}^{c} | T_{g}^{c} |
| Polymer | Code | NMR) | SEC) | D^{b} | (NMR) | (SEC) | (° C.) | (° C.) |
| PGATA | P1 | 21 | 19 | 1.17 | 100 | 100 | 83 | 104 |
| | P2 | 22 | 25 | 1.17 | 100 | 100 | 78 | 104 |
| | P3 | 21 | 23 | 1.09 | 100 | 100 | 75 | 100 |
| PGATA- | P4 | 40 | 53 | 1.12 | 52 | 35 | 75 | −45, 103 |
| b-PnBA^{e} | P5 | 86 | 96 | 1.20 | 24 | 20 | 79 | −45, 105 |
| | P6 | 106 | 130 | 1.20 | 20 | 15 | 80 | −43,92 |
| PGATA- | P7 | 38 | 54 | 1.15 | 58 | 46 | 79 | −45, 105 |
| b-PnBA- | P8 | 134 | 99 | 1.29 | 16 | 24 | 98 | −44, 107 |
| b-PGATA^{f} | P9 | 147 | 124 | 1.16 | 14 | 18 | 12 | −43, 105 |
| PnBA | P10 | 56 | 56 | 1.04 | — | — | 276 | −43 |
| PGATA- | P11 | 64 | 61 | 1.06 | 12 | 9 | 268 | −42 |
| b-PnBA- | P12 | 69 | 67 | 1.07 | 19 | 16 | 287 | −44 |
| b-PGATA | P13 | 75 | 75 | 1.08 | 25 | 25 | 264 | −43 |
| PnBA | P14 | — | 90 | 1.04 | — | — | — | — |
| PGATA- | P15 | — | 126 | 1.18 | — | 29 | 292 | −45, 126 |
| b-PnBA- | P17 | — | 102 | 1.10 | — | 12 | 321 | −47, 127 |
| b-PGATA | | | | | | | | |

^{a}Number average molar mass determined by ¹H NMR spectroscopy
^{b}Number average molar mass and polydispersity determined by SEC-MALLS in THF at room temperature.
^{c}Decomposition temperature at 5% weight loss determined by thermal gravimetric analysis (TGA).
^{d}Glass transition temperature determined by differential scanning calorimetry (DSC): the values near −45° C. correspond to poly(nBA) domains and the T_{g} for the poly(GATA) domains are around 100° C.
^{e}All diblock copolymers were synthesized using P1 as the macro-CTA.
^{f}Corresponding macro-CTA for P7 was P2, and P3 was chain extended to achieve the other two triblock copolymers (P8 and P9).

### Example 8—Peel Adhesion Tests

ABA-type copolymers are appealing for TPE applications and P9, as an illustrative example, was selected to be examined for its PSA properties. With 14% GATA, this triblock is a tacky material at room temperature and was tested for its peel adhesion. The force required to remove an adhesive from a substrate is responsible for the peel strength. For adhesion testing, solutions of 30 wt % of the polymers were uniformly spread on a polyethylene terephthalate (PETE) film. After complete evaporation of the solvent, the coated films were adhered onto a stainless steel plate and the peel resistance was measured by pulling the adhered films off the steel plate in 180° direction. P9 (poly(GATA)-poly(nBA)-poly(GATA): 11-125-11 kDa) exhibited a peel strength of 1.05±0.12 Ncm⁻¹ when the neat polymer was examined as an adhesive material. The peel adhesion was also tested for a mixture of the polymer and a tackifier. The use of a tackifier moderates the plateau modulus by diluting the entanglements in the midblock leading to more effective PSAs. Addition of a rosin ester tackifier, 30 mass percent of the polymer weight, boosted this value to 2.31±0.14 Ncm⁻¹. As a comparison, paper tape, adhesive tape, electrical tape, and repositionable notes offer peel adhesion values of 2.4, 1.9, 1.8, and 0.3 Ncm⁻¹, respectively, under similar experimental conditions.

Samples with lower GATA content in the polymer series were evaluated for their adhesion properties. As shown in TABLE 2, the peel adhesion significantly drops from P11 to P12 with an increase in GATA content (12 and 19 wt %, respectively). Addition of more GATA in P13 (25 wt %) resulted in a dry/rubbery material with nearly no tack. P11 and P9 exhibited excellent adhesion properties (with peel adhesion of 2.01 and 2.31 Ncm⁻¹, respectively) that are comparable or superior to many commercial PSA products (such as repositionable tape, electrical tape, paper tape, etc.). Samples P16 and P17 exhibited even higher peel adhesion values of 3.4 and 5.07 Ncm⁻¹, respectively.

TABLE 2

| | NMR | SEC | | | | |
|---|---|---|---|---|---|---|
| | Mₙ^{a}, kDa | Mₙ^{b}, kDa | Peel | | | ε^{f} |
| | (GATA | (GATA | Adhesion | E^{d} | σ^{e} | (% |
| Sample | wt %) | wt %) | (N/cm) | (kPa) | (kPa) | elongation) |
| P9 | 147(14) | 124(18) | 2.31 ± 0.14^{c} | NA | NA | NA |
| P11 | 64(12) | 61(9) | 2.01 ± 0.38^{c} | NA | NA | NA |
| P12 | 69(19) | 67(16) | 0.29 ± 0.05 | 440 ± 10 | 312 ± 10 | 123 ± 8 |
| P13 | 75(25) | 75(25) | NA | 560 ± 50 | 573 ± 48 | 171 ± 12 |
| P15 | — | 126(29) | — | 370 ± 20 | 650 ± 18 | 403 ± 9 |
| P16 | — | 110(18) | 3.40 ± 0.38 | — | — | — |
| P17 | — | 102(12) | 5.07 ± 0.23 | — | — | — |

^{a}Number average molar mass determined by ¹H NMR spectroscopy
^{b}Number average molar mass and polydispersity determined by SEC-MALLS in THF at room temperature.
^{c}This value is for the mixture of the polymer and 30 weight percent of a tackifier, and the peel adhesion for neat polymer was 1.05 ± 0.12 and 1.44 ± 0.31 for P9 and P11, respectively.
^{d}Young's modulus calculated at the first 5% elongation.
^{e}Average stress at break for 5 measurements.
^{f}Average maximum elongation.

For adhesion testing, solutions of the polymers (or a mixture of the polymer and tackifier) in ethyl acetate (EtOAc) were cast on a polyethylene terephthalate (PETE) film. Rosin esters were used as the tackifier (Sylvalite RE-80HP) and the tackifier concentration was 30 weight percent of the total solid content, where appropriate. The concentration of polymer/tackifier solution was 30 weight percent. As a representative example, 200 mg of P9 was dissolved in 520 μl EtOAc (or when using a tackifier, 140 mg of P9 and 60.0 mg of the Rosin ester tackifier were dissolved in 520 μl EtOAc). Then, the solution was evenly spread on a PETE film using a standard laboratory drawdown rod (two centimeters in diameter). The film was dried at room temperature open to air in a chemical fume hood overnight. The resultant coated PETE film was cut into 2-cm wide strips for adhesion testing. The strips were approximately 5 cm long.

180° Peel Adhesion Testing: The peel strength of the polymers was measured using a Shimadzu AGS-X tensile tester at a peel rate of 305 mm per minute. Two centimeter wide strips of the coated PETE films were placed on a clean stainless steel panel, as an adherend. To develop good contact between the adhesive and the steel plate, the coated film was gently pressed against the steel plate by manually rolling an electric tape roll on it. The strip was then peeled from the stainless steel panel. The reported average peel force and standard deviation values were acquired from at least five replicates.

### Example 9—Small-Angle X-Ray Scattering (SAXS) Analysis

FIGS. 7A-7C are charts presenting 1-dimensional synchrotron small-angle X-ray scattering (SAXS) analysis of sample polymers. Small-angle X-ray scattering (SAXS) experiments were performed at the Sector 5-ID-D beamline of the Advanced Photon Source (APS) at Argonne National Laboratories, maintained by the Dow-Northwestern-Dupont Collaborative Access Team (DNDCAT), unless otherwise mentioned. The source produces X-rays with a 0.70 Å wavelength. The sample to detector distance was fixed at 7.491 m. Scattering intensity was monitored using a Mar 165 mm diameter CCD detector operating with a resolution of 2048 by 2048. The two dimensional scattering patterns were azimuthally integrated to afford one-dimensional profiles presented as spatial frequency (q) versus scattered intensity. Samples were annealed at 140° C. for 2 hours before the SAXS experiments. Small angle x-ray scattering (SAXS) was employed to further investigate the fidelity of phase-segregation in these triblock copolymer materials. After solvent casting, the polymer samples were annealed at 140° C. for two hours for SAXS analysis. The SAXS profile for a bulk sample generated from P9 is shown in FIG. 4(a). A strong principal reflection (q*) indicates phase-separation between the two segments in this copolymer. Although the higher order reflections are not very well-defined, the peak position ratios of the observed broad features suggest a disorganized spherical morphology. SAXS analysis of P12 revealed an intense primary peak along with higher order broad reflections (FIG. 4(b)). The relative peak positions (q/q*)=√3 and √7 can be associated with a cylindrical structure. Principal reflections corresponding to phase-segregation were also observed for bulk samples generated from P11 and P13.

### Example 10—Stress-Strain Curves

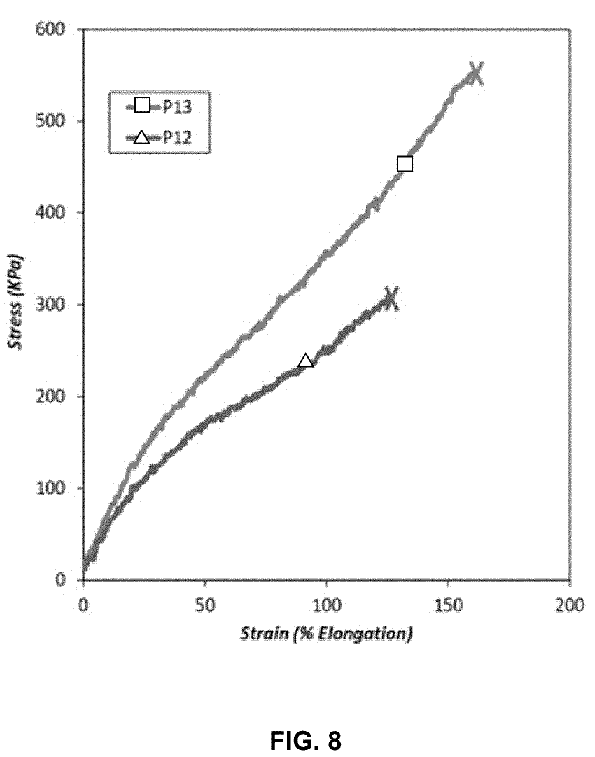

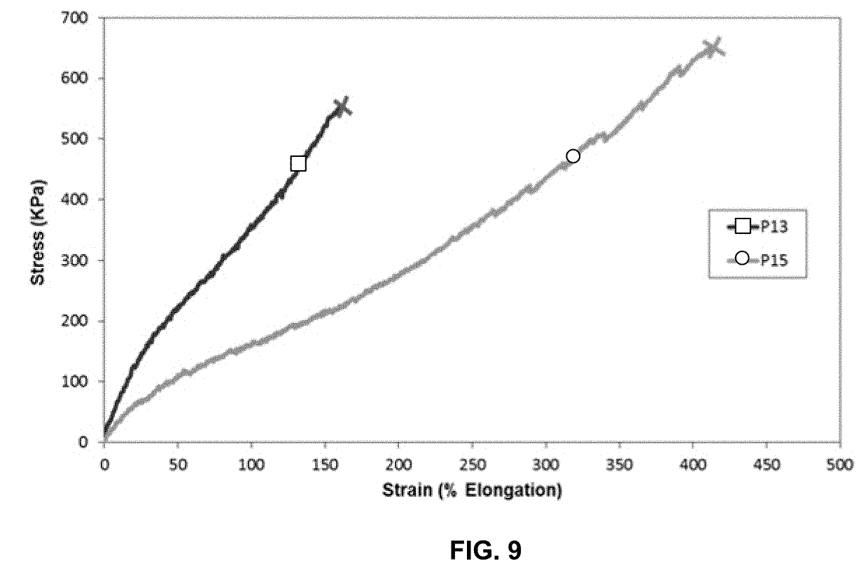

FIG. 8 is a chart presenting stress-strain curves for sample polymers P12 and P13. FIG. 9 is a chart presenting stress-strain curves for sample polymers P13 and P15. Tensile testing was performed using a Shimadzu AGS-X tensile tester at room temperature on tensile bars that had gauge dimensions of approximately 10 mm×8 mm×0.2 mm. All samples were elongated at a speed of 5 mm per minute. Samples were annealed at 140° C. for 1-2 hours before testing. Five replicate tensile bars of each polymer sample were conducted. The tensile properties of these triblocks were also investigated. Due to the high tack in P11 and P9 (12 and 14 wt % GATA, respectively) at ambient temperature, only samples of P12 and P13 were able to be prepared for tensile testing. At low strain, a linear response was observed in the stress-strain curves for both P12 and P13 triblocks, which represents a Young's modulus of 4.4 and 5.6 kPa, respectively (TABLE 2). The stress at break and maximum elongation for P12 and P13 (TABLE 2) are comparable to previously reported examples with similar nBA midblock length and very high T_{g} end blocks, such as poly(α-methylene-γ-butyrolactone) (PMBL), while for P15, these values are even higher.

Various examples have been described. These and other examples are within the scope of the following claims.

What is claimed is:

1. A composition comprising a block copolymer, wherein the block copolymer comprises at least one poly(glucose-6-acrylate) (G6A) block.

2. The composition of claim 1, wherein the poly(G6A) block comprises at least one block comprising repeating units of one or more monomers having a formula: 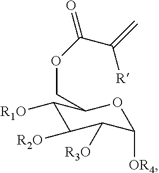
where R′=Me or H, wherein one or more of R₁, R₂, R₃, or R₄ are same or different, and wherein R₁, R₂, R₃, or R₄═H, Ac, Me, or Et.

3. The composition of claim 1, wherein the poly (G6A) block comprises at least one poly(glucose-6-acrylate-1,2,3,4-tetraacetate) (GATA) block.

4. The composition of claim 1, wherein the block copolymer further comprises at least one poly(n-butyl acrylate) (nBA) block.

5. The composition of claim 4, wherein the block copolymer comprises poly(glucose-6-acrylate-1,2,3,4-tetraacetate)-b-poly(nBA).

6. The composition of claim 4, wherein the block copolymer comprises poly(glucose-6-acrylate-1,2,3,4-tetraacetate)-b-poly(nBA)-b-poly(glucose-6-acrylate-1,2,3,4-tetraacetate).

7. The composition of claim 1, wherein the block copolymer comprises a junction block.

8. The composition of claim 7, wherein the junction block comprises at least one of a trithiocarbonate junction or a 3,5-Bis(loxopropoxy)benzoic acid junction.

9. The composition of claim 1, wherein the block copolymer comprises a polymer having a formula chosen from: 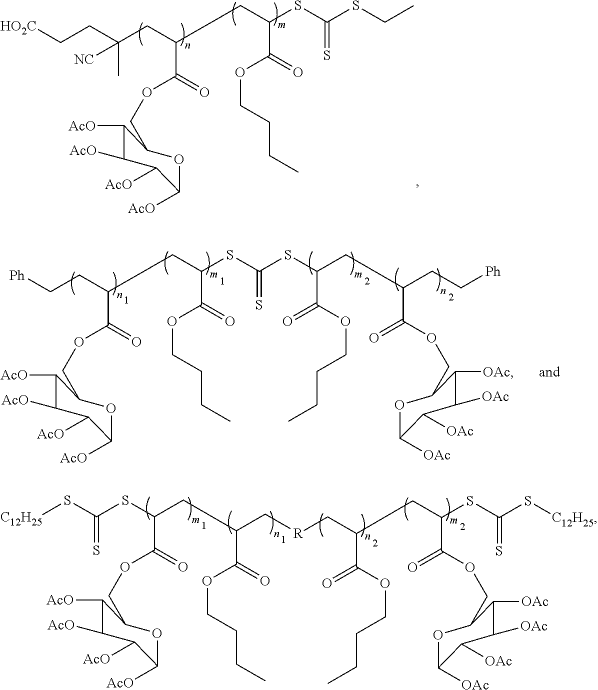
wherein 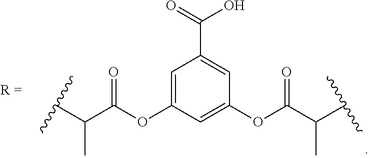
wherein n, n₁, n₂, m, m₁, m₂ are integers, wherein n₁ and n₂ are substantially equal, and wherein m₁ and m₂ are substantially equal.

10. The composition of claim 1, wherein the block copolymer comprises a thermoplastic elastomer.

11. The composition of claim 1, wherein the composition has a peel adhesion value of greater than or equal to about 1 N/cm.

12. A composition of claim 1, wherein the block copolymer has a thermal decomposition temperature of greater than or equal to about 275° C. associated with a weight loss of less than or equal to about 5%.

13. A composition comprising a pressure sensitive adhesive, the pressure sensitive adhesive comprising the composition of claim 1.

14. A composition comprising a block copolymer, wherein the block copolymer comprises
at least one glassy block comprising repeating units of poly(glucose-6-acrylate-1,2,3,4-tetraacetate); and
at least one other block comprising repeating units of one or more monomers chosen from: 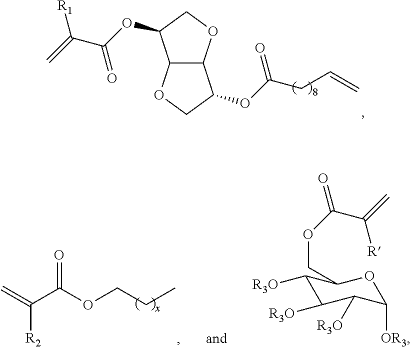
wherein R₁═CH₃ or H, R₂═CH₃ or H, X=2-10, R=Me or H, and wherein R₃═H, Ac, Me, or Et.

15. The composition of claim 14, wherein the block copolymer comprises a junction block, wherein the junction block comprises at least one of a trithiocarbonate junction or a 3,5-Bis(loxopropoxy)benzoic acid junction.

16. The composition of claim 15, wherein the block copolymer has a substantially symmetric structure about the junction block.

17. A method comprising treating glucose-6-acrylate-1,2,3,4-tetraacetate) (GATA) monomer and n-butyl acrylate (nBA) monomer with a free radical initiator in the presence of a chain transfer agent (CTA) to form a block copolymer, wherein the block copolymer comprises at least one poly(GATA) block and at least one poly(nBA) block.

18. The method of claim 17, wherein the CTA is chosen from 4-cyano-4-[(ethylsulfanylthiocarbonyl)sulfanyl] pentanoic acid, S,S-dibenzyl trithiocarbonate, and 3,5-Bis(2-dodecylthiocarbonothioylthio-loxopropoxy)benzoic acid.

19. The method of claim 17, further comprising:
treating the GATA monomer with the CTA to form a poly(GATA)-CTA intermediate; and
treating the poly(GATA)-CTA intermediate with the nBA monomer.

20. The method of claim 17, further comprising:
treating the nBA monomer with the CTA to form a poly(nBA)-CTA intermediate; and
treating the poly(nBA)-CTA intermediate with the GATA monomer.
